(19) United States
(12) Patent Application Publication
(10) Pub. No.: US 2012/0068934 A1
(43) Pub. Date: Mar. 22, 2012

(54) INTERACTIVE KEYBOARD WITH VIEWABLE DISPLAY

(75) Inventor: Glen C. Larsen, Issaquah, WA (US)

(73) Assignee: MICROSOFT CORPORATION, Redmond, WA (US)

(21) Appl. No.: 12/885,154

(22) Filed: Sep. 17, 2010

(51) Int. Cl. G06F 3/02

(52) U.S. Cl. 345/168

(57) ABSTRACT

A keyboard with viewable output display capability is provided. The keyboard includes a display device and a plurality of keys situated over the display device, each of the plurality of keys being mechanically depressible so that the key is reciprocally movable toward and away from the display device, and each of the plurality of keys being further configured to permit image light from the display device to pass through the key. The keyboard further includes an electrical trace network underneath the plurality of keys and formed at least in part from a transparent conductive material to permit image light from the display device to pass through the electrical trace network, the electrical trace network being operable, for each of the plurality of keys, to produce an electrical signal associated with the key in response to depression of the key toward the display device.

### BACKGROUND

Computer peripherals are continually being refined to expand functionality and provide quality user experiences. One area of improvement has been to provide peripheral devices that combine keyboard-type input functionality with the ability to display output to the user. In many cases, this is implemented by providing a keyboard with a display region that is spatially separate from the keys. For example, in a conventional keyboard layout, a rectangular liquid crystal display (LCD) can be situated above the function keys or number pad.

Another approach to combining input and output capability in a peripheral device is the use of a virtual keyboard on a touch interactive display. In this case, the display capability is provided directly on the keys: each key typically is displayed by the touch interactive display with a legend or symbol that indicates its function. The virtual keyboard approach has many benefits, including the ability to dynamically change the display for each key. Interactive touch displays are often less desirable, however, from a pure input standpoint. Specifically, touch displays do not have mechanically-depressible keys, which can provide a more, responsive and agreeable typing experience. On the other hand, mechanical keyboards do not provide the visual interactivity that is increasingly being expected in connection with computer peripherals.

### SUMMARY

The present application is directed to a keyboard with viewable output display capability. The keyboard includes a display device, a plurality of keys situated over the display device, with each of the keys being mechanically depressible so that the key is reciprocally movable toward and away from the display device. Furthermore, each of the keys is configured to permit image light from the display device to pass through the key. The keyboard also includes an electrical trace network underneath the keys and formed at least in part from a transparent conductive material to permit image light from the display device to pass through the electrical trace network. The electrical trace network is operable, for each of the plurality of keys, to produce an electrical signal associated with the key in response to depression of the key toward the display device.

In this way, the electrical trace network may be provided in the keyboard to enable detection of key input without interfering with imagery that may be projected through the electrical traces. Therefore, in some examples the viewing area through the keycaps may be increased when an at least partially transparent electrical trace network is used.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts an exemplary computing system including a keyboard that provides the ability to display output in connection with the keys of the keyboard.

FIG. 2 shows an illustration of the keyboard FIG. 1 in which a keyboard module is attached to a display device.

FIG. 3 illustrates an example of the output display capability that may be employed in connection with the keyboard of FIGS. 1 and 2.

FIG. 4 shows an exploded cross-sectional view of an example key included in the keyboard shown in FIGS. 1 and 2, with the figure also showing portions of the underlying electrical trace network and display device.

FIG. 5 shows an exploded view of an electrical trace network that may be use with the keyboard of FIGS. 1 and 2.

FIG. 6 shows an example of a trace network layer that may form part of the electrical trace network of FIG. 5.

FIG. 7 shows a method of making a keyboard having viewable output display capability.

FIGS. 8-10 show embodiments of a mechanical understructure provided in the keyboard shown in FIGS. 1 and 2.

### DETAILED DESCRIPTION

The present disclosure is directed to a keyboard and associated computing system in which the keyboard provides viewable output display capability, and additionally acts as an input device. The keyboard includes mechanically-depressible keys situated over an underlying display device. The keys have a central viewing window, or are otherwise configured to permit image light from the underlying display device to pass through the keys for viewing by a user.

In response to depression of a key toward the underlying display device, the keyboard electrically produces a signal associated with the key (e.g., to activate entry of a particular alphanumeric character). The electrical signal functionality is provided by an electrical trace network located underneath the keys. The electrical trace network may include an upper trace set and a lower trace set. Depression of a given key causes a resilient deformation in which a portion of the upper trace set is brought into electrical contact with an associated portion of the lower trace set. This contact produces the electrical signal associated with the key, which in turn is applied as an input to control a computing device.

The keyboard typically is configured to maximize the ability of a user to view images from the display device underlying the mechanically-depressible keys. Therefore, it will often be desirable to employ transparent materials in the construction of the various structures situated between the display device and the vantage point of a user. For example, as indicated above, the keys will often have a central viewing window. In some cases, the window is implemented with a transparent material; another option is for the center of the key to be hollow to permit direct viewing of the display. The mechanical understructure of the key (e.g., scissors, post-and-plunger, etc.) may also be made transparent. In addition, as will be described in numerous examples, the electrical trace network may instead be formed from transparent materials to permit image light from the display device to pass through the electrical trace network. Furthermore, in some cases, the electrical trace network may be routed around cutouts for the keys in the membrane sheets, allowing the centrally hollow portion of each key to extend all the way to the display device. When the trace sets are formed of a transparent material, there is less of a constraint on a user's ability to view image light from the underlying display device, thereby improving display capability.

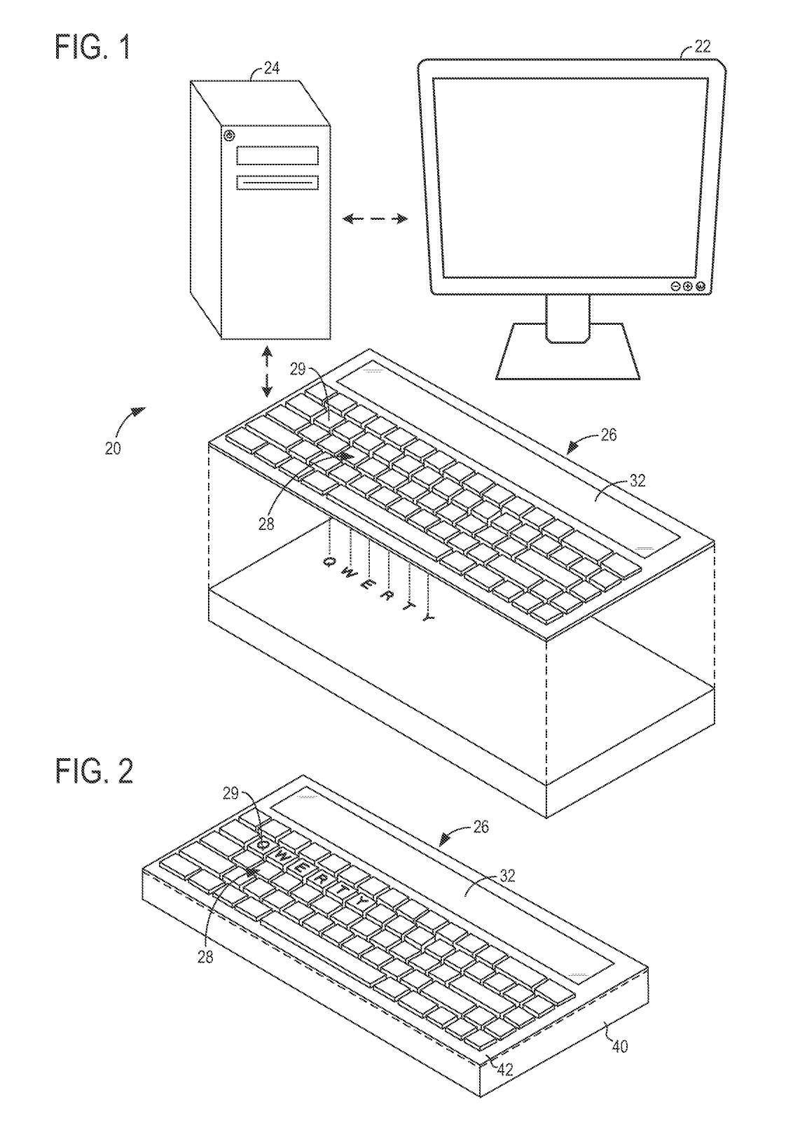

FIG. 1 depicts an exemplary computing system 20 including a display monitor 22, a computing device/component enclosure 24 (e.g., containing a processor, memory, hard drive, etc.), and a computer peripheral in the form of keyboard 26. The computing device may be in wired/wireless communication with the display monitor and/or the keyboard. FIG. 2 provides an additional view of keyboard 26 and exemplary components that may be used in its construction. As will be described in various examples, keyboard 26 may be implemented to provide displayable output in addition to keyboard-type input functionality.

In some examples, displayable output of the keyboard is provided from an LCD or other display device. The image light from the display device is viewed through mechanically-depressible keys disposed over the top of the display device. Individual keys are depressed to provide inputs, for example, in the form of electrical signals to control computing system 20.

The terms “input” and “output” will be used frequently in this description in reference to example keyboard embodiments. When used in connection with a keyboard key, the term “input” will generally refer to the input signal that is provided by the keyboard in response to operation of the key. “Output” will generally refer to the display provided for a key, such as the displayed legend, icon, or symbol that indicates the function of the key.

As indicated by the “Q”, “W”, “E”, “R”, “T”, “Y”, etc., on keys 28 (FIGS. 1 and 2), it will often be desirable that keyboard 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, keys 28 of the keyboard may be variously configured to provide other inputs. Keys may be assigned, for example, to provide functionality for various languages and alphabets, and/or to activate other input commands for controlling computing system 20. In some implementations, the key functions may adapt and/or change dynamically, for example in response to the changing operational context of software running on computing system 20. For example, upon pressing of an “ALT” key, operation of a key that otherwise is used to enter the letter “F” might instead result in activation of a “File” menu in a software application. Generally, it will be understood that the keys in the present examples may be selectively depressed to produce any type of input signal for controlling a computing device.

Keyboard 26 can provide a wide variety of displayable output. In some examples, the keyboard causes a display of viewable output on or near the individual keys 28 to indicate key function. This can be seen in FIGS. 1 and 2, where instead of keys with letters painted, printed or etched onto a keycap surface, a display mechanism (e.g., an LCD device situated under the keys) is used to display the “Q”, “W”, etc., functions of the keys. This dynamic and programmable display capability facilitates potential use of keyboard 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided does not have to be associated with the input functionality of the keyboard. Images might be provided, for example, for aesthetic purposes, to personalize the user experience, or to provide other types of output. The present disclosure encompasses display output for any purpose, including purposes other than to indicate the function of particular keys.

Also, in addition to display provided on or near keys 28, display functionality may be provided in other areas, for example in an area 32 located above keys 28. Still further, area 32 or other portions of keyboard 26 may be provided with touch or gesture-based interactivity in addition to the keyboard-type input provided by keys 28. For example, area 32 may be implemented as an interactive touchscreen display, via capacitive-based technology, resistive-based technology, or other suitable methods. Also, as described elsewhere herein, the portion of the device that underlies the keyboard may also include capabilities in addition to display, including touch sensitivity, machine vision and the like.

Turning now to FIG. 2, keyboard 26 may include an underlying display device 40 and a keyboard module 42 disposed over and secured to the display device. The keyboard module may include keys 28, a plurality of mechanical understructures, and/or an electrical trace network, discussed in greater detail herein. Keys 28 are mechanically movable toward and away from underlying display device 40. Underneath keys 28 is an electrical trace network (not visible in FIG. 2) that provides electrical signals in response to depression of keys 28.

A variety of types of display device 40 may be employed. As indicated briefly above, one type of suitable display device is an LCD device. References to an LCD or other specific type of display device are non-limiting; the keyboard examples discussed herein may include any display type suitable for use with overlying mechanically-depressible keys.

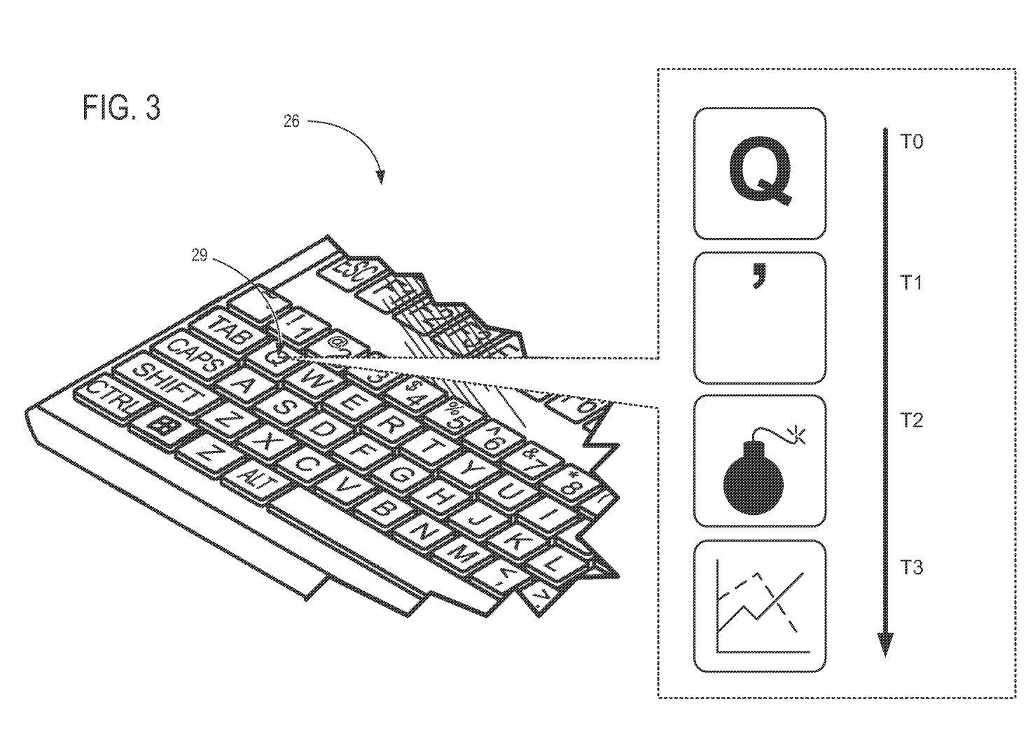

FIG. 3 provides further illustration of how the display capability of keyboard 26 may be employed in connection with an individual key 29. In particular, as shown respectively at times T0, T1, T2, etc., the display output associated with key 29 may be changed, for example to reflect the input command produced by depressing the key. However, as previously mentioned, the viewable output provided by the keyboard may take forms other than displays associated with individual keys and their input functionality.

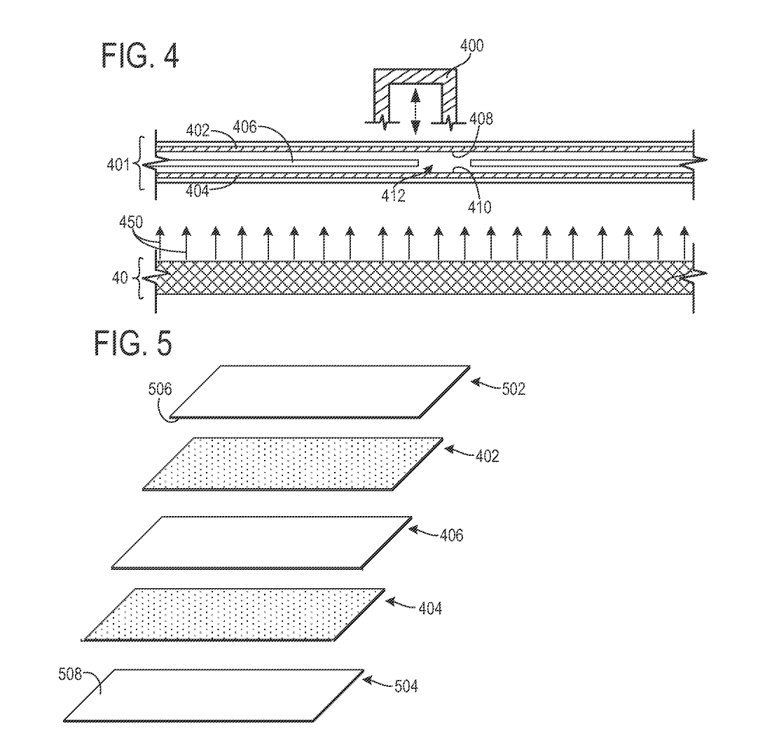

FIG. 4 is an exploded cross-section view of a mechanically-depressible key 400 and underlying keyboard structures. It will be appreciated that key 400 may be one of keys 28 shown in FIGS. 1 and 2. Relative dimensions in the figure are for the purposes of illustration and clarity only; actual dimensions typically will vary from those in the figures. Underneath the key are portions of electrical trace network 401 and display device 40, which provides image light 450 that is directed upward for viewing by a user through key 400 and electrical trace network 401. The directional arrows associated with image light 450 are exemplary only, and it is contemplated that the image light can be diffuse and/or emanating in directions other than those indicated by the arrows. As indicated by upward and downward arrows, key 400 is reciprocally movable toward and away from display device 40. As will be further explained below, a mechanical understructure may be provided to guide key movement, provide upward return force and/or provide tactile user feedback.

Electrical trace network 401 is operable, upon depression of key 400, to produce an electrical signal associated with the key (e.g., to command entry of an alphanumeric character). In many examples, electrical trace network 401 will have a layered structure, in which an upper trace set 402 and a lower trace set 404 are separated by an insulator 406. Both the upper trace set 402 and lower trace set 404 may include multiple electrical traces in various patterns and topographies, which in many cases can be intricate and extensive, to provide associated, individualized electrical signals for all of the keys of a keyboard.

Depression of key 400 causes a resilient deformation in a portion of electrical trace network 401 to produce an electrical signal. Specifically, the resilient deformation results in a portion 408 of upper trace set 402 being brought into contact with an associated portion 410 of lower trace set 404. The contact may occur through a hole 412 formed in insulator 406 for the purpose of permitting the associated portions to electrically contact one another. When employed for an entire keyboard, insulator 406 typically includes a hole for each of the mechanically-depressible keys of the keyboard. In this way, each key may produce an electrical signal via electrical trace network 401 responsive to depression of the key. Viewed from the top, the insulating sheet will typically appear as an expanse with holes distributed throughout.

FIG. 5 is an exploded view providing further illustration of exemplary configurations for electrical trace network 401 and related structures. As indicated, an exemplary construction may include an upper substrate 502, upper trace set 402, insulator 406, lower trace set 404, and lower substrate 504.

Upper substrate 502 may be formed in various configurations. In some examples, the upper substrate has a cutout for each key to permit passage of image light from a display device. For example, the substrate may include a cutout for each key, with the cutout being aligned with the central viewing window of the keycap. Additionally, or alternatively, the upper substrate may be formed from a transparent material to permit passage of image light. The substrate may also be flexible or otherwise configured to allow for resilient deformation in response to downward pressure resulting from key operation. In particular, in some examples the upper substrate 502 is implemented as a transparent flexible sheet with the upper trace set applied to an underside of the sheet (i.e., facing insulator 406, lower trace set 404, and lower substrate 504). Regardless of the particular implementation, upper trace set 402 may be applied to a downward-facing surface 506 of upper substrate 502. In this way, the upper trace set is disposed on a surface of the upper substrate, where the surface of the upper substrate faces the display device.

Lower substrate 504 similarly may be formed with a transparent material and/or cutouts for the keys, and may be flexible to permit selective contact between associated portions of the trace sets. In some cases, the lower substrate is implemented as a base sheet that is situated over a display device, for example between lower trace set 404 and display device 40. In other examples, the lower substrate is the outer surface of the display device (e.g., an outer glass surface or coating of an LCD device). Regardless of the particular implementation, lower trace set 404 may be applied to an upward-facing surface 508 of the lower substrate 504. In this way, the lower trace set is disposed on a surface of the lower substrate facing away from the display device. In some examples, the resilient deformation is provided largely as a result of the material properties of the upper material, and the lower substrate may be formed of a more rigid material such as glass. In fact, in some cases, the lower substrate may be the outer surface of the LCD device.

When insulator 406 is employed, it may be implemented using transparent materials and/or key cutouts, similar to the upper and lower substrate. In implementations where the various layers are transparent, the upper and lower substrate and the insulator may be implemented as polyester sheets (e.g., PET), or layers of another suitable transparent material. In many embodiments, insulator 406 will be an insulative sheet having a plurality of holes, with each hole corresponding to a particular key of the keyboard and its associated portions of upper trace set 402 and lower trace set 404. Thus, insulator 406 may be a transparent insulative sheet insulating the upper trace set from the lower trace set.

Still referring to FIG. 5, the electrical trace network may be formed from various materials using various methods. Typically, some or all of electrical trace network 401 will be formed from a transparent conductive material to permit passage of image light through electrical trace network 401.

Transparent conductive materials may be printed, deposited, or otherwise applied to the substrates depicted in FIG. 5. In one example, a transparent conductive oxide may be employed, such as indium-tin oxide. Another option is to employ a transparent conductive polymer, such as Poly(3,4-ethylenedioxythiophene) (PEDOT) or PSS-doped PEDOT. Yet another alternative is to form the conductor using carbon nanotubes, for example in a thin film deposited on the substrates.

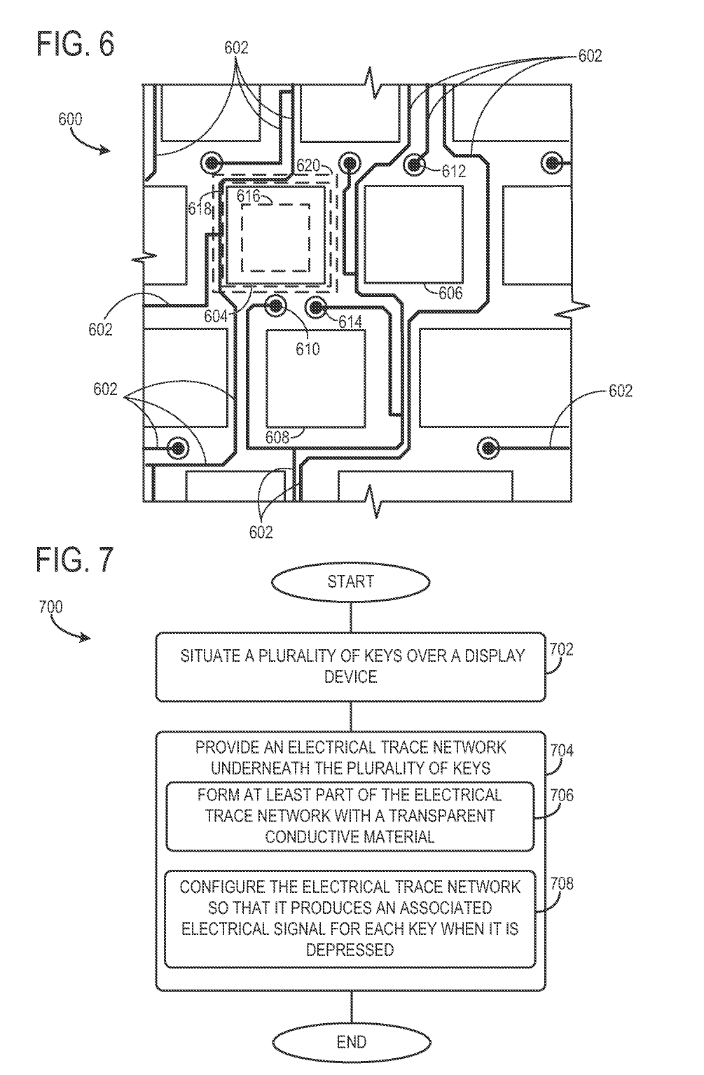

FIG. 6 shows an example substrate 600 with a trace set 602 applied to the substrate. It will be appreciated that trace set 602 may be included in the electrical trace network shown in FIG. 4. For example, trace set 602 may be upper trace set 402 or lower trace set 404. Trace set 602 is depicted as bold lines in a varied topology around key regions 604, 606, and 608 of the substrate. Each key region corresponds to a key positioned above the substrate and over a portion of an underlying display device. The solid bold circles of the trace set each represent a trace portion corresponding to one of the key regions that may be brought into contact with an associated portion of another trace set (not depicted). As previously explained, this selective electrical contact activates an electrical signal for the key corresponding to the key region. For example, solid bold circle 610 is a conductive lead for key region 604; solid bold circle 612 is a conductive lead for key region 606; and solid bold circle 614 is a conductive lead for key region 608.

Referring to key region 604, FIG. 6 will be considered from three different alternate perspectives. In a first perspective, it will be assumed that the overlying key and associated structures result in an effective viewable area denoted by dashed box 616. In other words, the key and other structures of the embodiment permit through-key viewing of image light from an underlying display in an area within the region defined by dashed box 616. The viewable area may be affected by various factors, including the structure and materials employed for the overlying keys.

In a second alternate perspective, the embodiment of the overlying non-depicted structures allows for a larger viewable area, denoted by dashed box 618. This may result, for example, through implementation of an alternate construction for the overlying key. In a third alternate perspective, a still larger viewable area has been achieved (denoted by dashed box 620), though it will be appreciated from the figure that the example trace set 602 overlaps the area defined by the dashed box 620. In one particular example, the key region may be 19 millimeters (mm) by 19 mm and the viewable area may be 13 mm by 13 mm. However, the key region and viewable area may have other dimensions.

From this third perspective (i.e., corresponding to dashed box 620), it will be appreciated that the use of transparent conductive materials may in some cases allow for improved display capability. In particular, when the trace set 602 is partially or completely transparent, it places less of a constraint on a user's ability to view/see image light from the underlying display, because the image light passes through the electrical traces. The viewable area of the display would then be determined by the structure and characteristics of the overlying mechanically-depressible keys, or at least without being constrained by the electrical trace network. In fact, if the entire electrical trace network is made of a sufficiently transparent conductive material, it can be made in any convenient topography or arrangement, without having to consider whether or not any portion of it will obscure image light.

It will be further appreciated that the present discussion encompasses a method of making a keyboard having viewable output display capability. An example of such a method is shown at 700 in FIG. 7. At 702 the example method includes situating a plurality of keys over a display device. As in the examples above, each key is mechanically depressible relative to the display device and configured to permit passage of image light from the display device through the key.

At 704, the method includes providing an electrical trace network underneath the plurality of keys. This may include, as shown at 706, forming at least part of the electrical trace network with a transparent conductive material, so that image light from the display device can pass through the electrical trace network. Further, as shown at 708, the method may include configuring the electrical trace network so that it produces an associated electrical signal for each key when it is depressed.

The electrical trace network may be formed to include an upper trace set and a lower trace set, as described above. Further, flexible and/or resilient structures and materials may be employed to enable a resilient deformation in which specific portions of the trace sets are brought into contact to produce electrical signals associated with the mechanically-depressible keys.

As indicated in the above examples, the transparent conductive material may be formed as a transparent conductive oxide, transparent conductive polymer, or using carbon nanotubes, to name a few non-limiting examples.

Method 700 enables a transparent electrical trace network to be applied to a substrate of a keyboard. In such an arrangement, the transparency of the electrical trace network prevents optical interference of a displayed output projected through the substrate of the keyboard. Therefore in some examples, the viewable area through the keys may be expanded when a transparent electrical trace network is utilized, enhancing the keyboard's display capability.

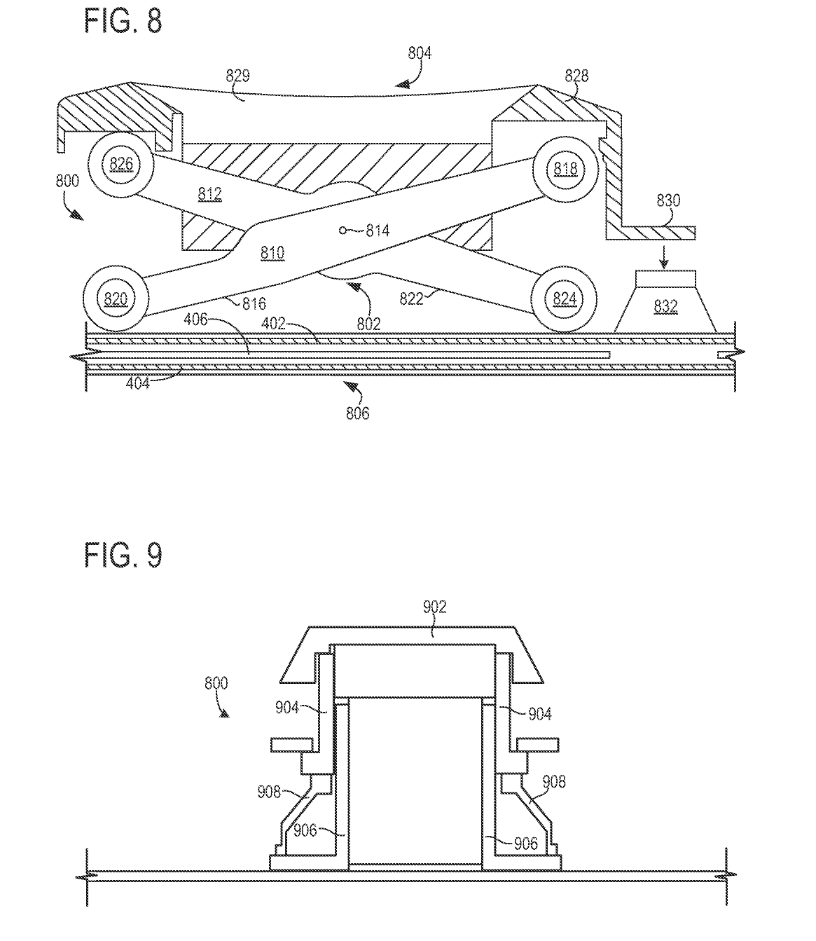

FIGS. 8-10 provide various examples of a mechanical understructure 800 that may be employed in connection with the individual mechanically-depressible keys disclosed herein. The various examples may provide one or more of the following functions in connection with key movement: (1) guide, stabilize and/or constrain the reciprocating key movement toward and away from the underlying display device; (2) provide a return force to urge the key back to its un-depressed position when released; and (3) provide tactile user feedback during operation of the key, such as providing a “snapping” feel when the key is depressed, as may be achieved, for example, through use of an elastomeric tactile dome structure.

Referring specifically to the example of FIG. 8, mechanical understructure 800 includes a scissors structure 802 that is disposed between a keycap 804 and a base structure 806 of keyboard 26, shown in FIG. 1. The scissors structure is configured to enable movement of the keycap 804 upward and downward relative to the base structure 806. In particular, scissors structure 802 is configured to maintain the keycap 804 in alignment during movement and ensure that the movement is constrained to perpendicular linear movement toward and away from the base structure, without twisting, tilting, and the like. For example, it will generally be preferable that the top of the keycap remain parallel with base structure 806 during movement of the keycap.

Scissors structure 802 may include two portions 810 and 812 that pivot relative to one another via pivot point 814. Each portion includes a pair of opposed webs with a pair of rods extending between the webs.

Specifically, portion 810 includes web 816. Rod 818 extends from a first end of web 816; rod 820 extends from a second end of web 816. The rods extend to an opposing similar web structure that cannot be seen in FIG. 8. The other portion 812 includes similar structures: web 822, rods 824 and 826, and an opposing web structure.

Scissors structure 802 may be variously configured and formed from a variety of different materials. In some embodiments, the entire structure may be plastic. It may be desirable in other examples to form some or all of the parts from metal. In particular, some embodiments employ plastic webs that are over-molded around metal connecting rods. Such use of metal rods may be advantageous when stiffness and rigidity are of particular concern, for example in the case of large format keys (e.g., the “spacebar” key or “enter” key of a keyboard).

It will be appreciated that the portions of the scissors structure 802 pivot relative to one another when the key is depressed downward toward base structure 806. The pivoting action results in an overall lowering of the scissors structure, and produces a slight increase in the effective length of the scissors structure. To accommodate this length variation, the scissors structure may be coupled with adjoining structures in a way that allows for some lateral movement. The portions of scissors structure 802 are engaged with keycap 804 and base structure 806 as follows:
Rod 818 is snapped into a pair of snap hooks (not shown) provided on the underside of keycap 804. This engagement allows rotation of the rod, as will occur during depression of the key, but maintains the lateral position of the rod relative to the keycap.
Rod 826 abuts the underside of keycap 804, but is allowed to slide somewhat laterally during depression of the key, to accommodate the effective lengthening of the scissors structure that occurs during collapse.
Rod 824 is held by a pair of snap hooks (not shown) on base structure 806, while rod 820 abuts the base structure but is permitted to slide laterally relative to the base structure. Similar to rods 818 and 826, this arrangement holds the scissors structure generally in place while allowing for the effective length variation that occurs during the pivoting operation of the scissors structure.

It will again be appreciated that the scissors structure may be disposed to the periphery of each key, thereby leaving the central area of the key/keycap unobstructed and maximally available for display purposes. In particular, when keycap 804 is viewed straight on from the top of the key, the webs and rods of the scissors structure are all positioned at the periphery of the key, underneath a perimeter piece 828 of the keycap. Thus, when an LCD or other display device is employed under the keyboard, the peripherally-configured scissors assemblies allow for a greater portion of the display to be viewed without obstruction through the key (i.e., through a transparent central piece 829). This arrangement, in conjunction with the transparent trace network, may result in a large increase in the unobstructed viewable area for each key.

Continuing with FIG. 8, other structures and mechanisms may be employed in connection with the actuation of the key. In the present example, as keycap 804 is depressed toward base structure 806, a plunger or tab-like protrusion 830 will depress a tactile structure, such as tactile feedback dome 832, which is associated with the key. As the key moves from a rest position toward its fully depressed state, the tactile feedback dome will eventually collapse and cause a palpable change in the action or feel of the key. It will be appreciated that other suitable tactile structures may include a spring such as a torsional, cantilever, and/or linear spring. The springs may be constructed out of a suitable material such as plastic or metal.

In addition to collapsing the feedback dome, the depression of the key causes occurrence of an electrical event that produces the input signal or command associated with the key. This may be achieved through use of a switch or other state detector that is responsive to depression of the keycap. As discussed above with regard to FIG. 4, the base structure may include insulator 406 interposed by upper trace set 402 and lower trace set 404 configured to establish an electrical connection in response to key depression, thereby producing an input signal. This is but one example of a switching mechanism; a variety of other state detectors may be employed, including detectors that detect more than whether the key is in an “up” or “down” state. For example, pressure detection or other methods may be used to determine multiple states, including intermediate key-press positions and/or the force applied to a key.

Regardless of the exact mechanism by which the signal is generated, use of a tactile structure can provide tangible, haptic feedback which affirms that the user's physical movement (i.e., pressing of the key) has sent the desired input signal to the attached computing device. The tactile structures typically are elastically deformable and may be implemented as tactile feedback domes formed from metal or silicone, or other elastomeric or rubber-like dome structures, to name but a few possible examples. Selection of a particular type of tactile structure may be informed by tradeoffs and considerations relating to key feel, keyboard thickness, display performance, manufacturing concerns, robustness, reliability and the like. Tactile feedback domes made of metal can often be employed to reduce the keyboard's thickness (relative to other types of domes), however in some cases these domes are less desirable from a tactile-feel standpoint. Conversely, a rubber-like tactile dome may provide the desired feel or action for the keyboard, but at the expense of an increased thickness which can affect the display performance.

As an alternative to the depicted arrangement, the tactile structures may be provided in other locations that do not impede display of images through the keycaps. For example, the tactile structure may be provided at a top or side edge of the holes in the base structure, as opposed to a bottom edge. Furthermore, tactile structures may be positioned underneath the mechanical understructure such that they are compressed by actuation of the mechanical understructure. Regardless of the particular configuration, the centrally-offset position of the tactile structures will often be desirable in that it minimizes or eliminates the possibility of interfering with the through-key display functionality.

FIG. 9 shows another embodiment of mechanical understructure 800. A cross-sectional side view of the mechanical understructure is depicted. Mechanical understructure 800 is coupled to a keycap 902. The keycap may be coupled to a stem 904 which at least partially encloses a silo 906. The silo or portions thereof may be surrounded by a resiliently-deformable tactile structure such as an elastomeric dome 908. resiliently deformable. Upon depression of the key the dome 908 may provide a resistive force, thereby providing tactile feedback. Furthermore, the silo may guide the reciprocating movement of the stem toward and away from display device 40, shown in FIG. 2. It will be appreciated that a portion of the stem may be hollow or see-through, enabling image light from the display device to pass through the key.

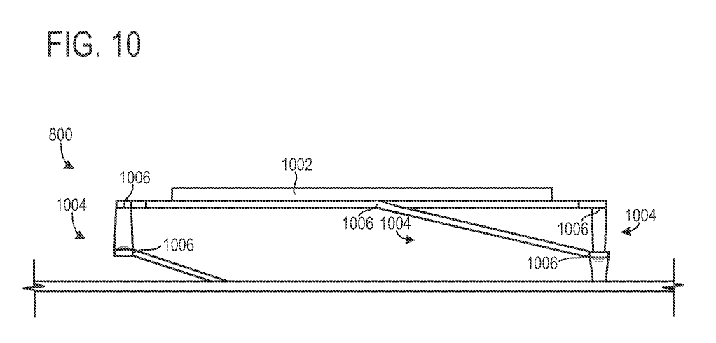

FIG. 10 shows another embodiment of mechanical understructure 800. Mechanical understructure 800 includes an upper construction 1002. The upper construction is coupled to a plurality of flexible extensions 1004. The plurality of flexible extensions may be configured to provide a return force in response to key down movement, enabling up and down movement of a key. Each flexible extension may include one or more resiliently deformable joints 1006. It will be appreciated that the position and geometry of the flexible extensions may be selected based on the characteristics of the material(s) used to construct the extensions. As previously discussed, an electrical trace network may be provided underneath mechanical understructure 800. The electrical trace network may be configured to produce an electrical signal associated with the key in response to depression of the key.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon which, upon execution by a computing device, cause the computing device to execute the methods described above and cause operation of the systems described above.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A keyboard with viewable output display capability, comprising:
a display device;
a plurality of keys situated over the display device, each of the plurality of keys being mechanically depressible so that the key is reciprocally movable toward and away from the display device, each of the plurality of keys being further configured to permit image light from the display device to pass through the key; and
an electrical trace network underneath the plurality of keys and formed at least in part from a transparent conductive material to permit image light from the display device to pass through the electrical trace network, the electrical trace network being operable, for each of the plurality of keys, to produce an electrical signal associated with the key in response to depression of the key toward the display device.

2. The keyboard of claim 1, where the transparent conductive material is a transparent conductive oxide.

3. The keyboard of claim 2, where the transparent conductive material is indium-tin oxide.

4. The keyboard of claim 1, where the transparent conductive material is a transparent conductive polymer.

5. The keyboard of claim 1, where the transparent conductive material is formed from carbon nanotubes.

6. The keyboard of claim 1, where the electrical trace network includes an upper trace set and a lower trace set, where for each of the plurality of keys, depression of the key causes a resilient deformation in which an associated portion of the upper trace set is brought into electrical contact with an associated portion of the lower trace set.

7. The keyboard of claim 6, where the upper trace set is disposed on a surface of a transparent flexible sheet situated underneath the plurality of keys, and where the upper trace set is insulated from the lower trace set by a transparent insulative sheet having a plurality of holes to permit electrical contact between portions of the upper trace set and portions of the lower trace set.

8. The keyboard of claim 7, where the lower trace set is disposed on a surface of a transparent base sheet situated between the transparent insulative sheet and the display device.

9. The keyboard of claim 7, where the lower trace set is disposed on an outer surface of the display device.

10. The keyboard of claim 1, where the keyboard includes, for each of the plurality of keys, a mechanical understructure for the key to provide tactile user feedback and guide reciprocating movement of the key toward and away from the display device.

11. A method of making a keyboard with viewable output display capability, comprising:
situating a plurality of keys over a display device, where each of the plurality of keys is mechanically depressible relative to the display device and configured to permit passage of image light from the display device through the key; and
providing an electrical trace network underneath the plurality of keys, where said providing includes:
forming at least a portion of the electrical trace network with a transparent conductive material to permit passage of image light from the display device through the electrical trace network; and
configuring the electrical trace network so that, for each of the plurality of keys, the electrical trace network produces an electrical signal associated with the key in response to depression of the key.

12. The method of claim 11, where forming at least a portion of the electrical trace network with a transparent conductive material includes forming the portion of the electrical trace network with a transparent conductive oxide.

13. The method of claim 12, where the transparent conductive oxide is indium-tin oxide.

14. The method of claim 11, where forming at least a portion of the electrical trace network with a transparent conductive material includes forming the portion of the electrical trace network with a transparent conductive polymer.

15. The method of claim 11, where forming at least a portion of the electrical trace network with a transparent conductive material includes forming the portion of the electrical trace network with carbon nanotubes.

16. The method of claim 11, where providing the electrical trace network includes forming an upper trace set and a lower trace set, where the upper trace set and the lower trace set are configured such that, for each of the plurality of keys, depression of the key causes a resilient deformation in which an associated portion of the upper trace set is brought into electrical contact with an associated portion of the lower trace set to produce the electrical signal associated with the key.

17. A keyboard with viewable output display capability, comprising:
a display device;
a plurality of keys situated over the display device, each of the plurality of keys being mechanically depressible so that the key is reciprocally movable toward and away from the display device, each of the plurality of keys being further configured to permit image light from the display device to pass through the key;
a mechanical understructure for each of the plurality of keys, the mechanical understructure being configured to provide tactile user feedback and guide reciprocating movement of the key toward and away from the display device; and
an electrical trace network underneath the plurality of keys, including an upper trace set formed at least in part from a transparent conductive material and a lower trace set formed at least in part from a transparent conductive material, the upper trace set and the lower trace set being configured so that, for each of the plurality of keys, depression of the key causes a resilient deformation in which an associated portion of the upper trace set is brought into electrical contact with an associated portion of the lower trace set to thereby produce an electrical signal associated with the key, where said electrical contact occurs through one of a plurality of holes in a transparent insulative sheet positioned between the upper trace set and the lower trace set.

18. The keyboard of claim 17, where the upper trace set is disposed on a surface of a flexible transparent sheet, where the surface of the flexible transparent sheet faces the display device.

19. The keyboard of claim 18, where the lower trace set is disposed on a surface of the flexible transparent sheet that faces away from the display device.

20. The keyboard of claim 18, where the lower trace set is disposed on a surface of a base transparent sheet that is situated between the flexible transparent sheet and the display device.
